(19) United States
(12) Patent Application Publication
(10) Pub. No.: US 2026/0183090 A1
(43) Pub. Date: Jul. 2, 2026

(54) Device and Method for Carrying Out an Intraoral Scan

(71) Applicant: Brütsch Elektronik AG, Beringen (CH)

(72) Inventors: René Fischli, Benken (CH); Martin Steiner, Uhwiesen (CH); Lorenz Sulzberger, Gächlingen (CH); Sebastian Pinzello, Dübendorf (CH)

(21) Appl. No.: 18/872,293

(22) PCT Filed: Sep. 2, 2023
(86) PCT No.: PCT/EP2023/074098

§ 371 Date: Dec. 6, 2024

(30) Foreign Application Priority Data
Sep. 2, 2022 (EP) 22193629.7

(51) Int. Cl. A61C 9/00; G06T 7/521; G06T 7/55

(52) U.S. Cl. CPC A61C 9/0053; G06T 7/521; G06T 7/55; G06T 2207/10024; G06T 2207/30036

(57) ABSTRACT

The invention relates to a method and a device for creating 3-dimensional images with an intraoral scanning device. According to the invention, a color pattern (111, 112, 113) is projected onto a surface to be captured—in particular the teeth (40). During projection, a plurality of images is recorded by at least 3 cameras (13) which are spaced apart from one another and arranged in a plane on the scanning device. Using the displacement of corresponding pixels, a depth map can be directly calculated. In a subsequent step, the calculated depth maps are merged and, finally, a 3D model is calculated. The essence of the invention is that the projected color pattern generates intensity profiles that are predominantly continuous in the individual color channels and matching pixels or patterns are detected by evaluation of the vectorial differences in the color space. The color pattern is projected intermittently. Novel solution approaches needed to be invented to realize micro-projection with high light intensity during flash operation.

### CROSS REFERENCE TO RELATED APPLICATIONS

This application is the U.S. national stage of International Application No. PCT/EP2023/074098, filed on 2023 Sep. 2. The international application claims the priority of EP 22193629.7 filed on 2022 Sep. 2; all applications are incorporated by reference herein in their entirety.

### BACKGROUND

The present invention relates to a method for capturing depth data in the oral cavity of a patient, as well as a device for performing these scans and for generating a 3D model of the captured area.

Such devices are also referred to as intraoral scanners.

By creating a 3D model of the scanned area in the patient's oral cavity, the teeth, dentures, crowns and bridges can be displayed and dental products can be manufactured without the conventional impression using an impression material. Previously necessary intermediate steps, such as the production of a plaster model and the use of an extraoral scanning system, can be eliminated by an intraoral scan.

The 3D models obtained from an intraoral scan can then be used in the computer-aided production of dental prostheses such as crowns or bridges, or for computer-aided dental diagnostics. This is a growing market.

A variety of different methods and devices for performing an intraoral scan are available on the market. All of the different methods have their advantages and disadvantages.

One possibility for capturing distance data is triangulation.

Here it is possible to take a distance measurement using only a camera and a projected pattern. In a single-camera approach, it is necessary to calibrate the correspondence between the patterns projected by the light source, e.g. stripes, and the stripes observed in the image.

Generally, the patterns captured by the camera differ from the projected pattern due to the different optical properties of the objects or materials to be scanned. This is particularly the case with teeth. For example, the pattern may have sharp edges, making exact triangulation and assignment to the pattern more difficult.

To be able to calculate as much depth information as possible, as many lines as possible must be displayed and evaluated. The problem here is that, on the one hand, the number of evaluable lines is limited by the optical properties of the teeth, and on the other hand, the assignment to the projected line can no longer be established. To ensure the assignment to the projected line, several images with stripes of different widths are usually taken and evaluated, with the disadvantage that the intraoral scanner moves between the images and this must be taken into account in the evaluation. Known alternative methods, which do not appear suitable due to the properties of the teeth, would be to code the stripes or use colored stripes.

Another approach is stereovision, in which spatial vision is made possible with the help of two cameras. However, it should be noted that there are also triangulation methods that use two cameras.

WO201 9085402A1 describes an intraoral scanner that works with at least one camera. For this reason, it is basically a scanner that is based on the triangulation method.

The basic principle of stereovision is that the same points on an object to be scanned are recorded by at least two cameras from different “viewing directions”.

The disparity detected in this way can be used to generate a depth map and ultimately a 3D image of the object to be scanned. As with the triangulation method, there are many different types of stereovision.

For example, there is active and passive stereovision. In contrast to active stereovision, passive stereovision does not require light to be projected onto the object to be scanned.

In active stereovision, a pattern is projected onto the object to be scanned using a light projection, which allows the disparity to be determined more clearly and accurately. Therefore, random patterns are often used here.

Teeth, in particular, which are also moist in the patient's mouth, exhibit many optical effects associated with partial translucency. Finely structured, random patterns can no longer be clearly recognized. Therefore, patterns are needed that are as clear as possible on the teeth and that allow image sections from the left and right images to be matched.

One possibility, in addition to black and white patterns, is to use colors and color gradients. This makes it very easy to identify the colors and enables good matching. The use of color strips allows for maximum contrast.

The arrangement of the cameras, projectors and the overall geometry, in particular of the distal section of the scanning device that is inserted into the oral cavity of a patient, is often designed differently for the known intraoral scanners and adapted to the scanning method used in each case.

Compared to the otherwise known 3D scanning methods, it must be taken into account that the geometric and optical properties in the oral cavity of a patient present high technical hurdles and the distal part of the intraoral scanner must be very small. For this purpose, special solutions have been developed in the prior art for intraoral scanners.

EP2166303A1 describes an intraoral scanner with a plurality of cameras alternately arranged with light projectors on the device.

WO2016142917A1 describes a scanning device that partially envelops the teeth during scanning.

### SUMMARY

The invention relates to a method and a device for creating 3-dimensional images with an intraoral scanning device. According to the invention, a color pattern (111, 112, 113) is projected onto a surface to be captured—in particular the teeth (40). During projection, a plurality of images is recorded by at least 3 cameras (13) which are spaced apart from one another and arranged in a plane on the scanning device. Using the displacement of corresponding pixels, a depth map can be directly calculated. In a subsequent step, the calculated depth maps are merged and, finally, a 3D model is calculated. The essence of the invention is that the projected color pattern generates intensity profiles that are predominantly continuous in the individual color channels and matching pixels or patterns are detected by evaluation of the vectorial differences in the color space. The color pattern is projected intermittently. Novel solution approaches needed to be invented to realize micro-projection with high light intensity during flash operation.

### DETAILED DESCRIPTION

The object of the present invention is to provide an improved scanner and an improved device of the type mentioned at the beginning, which enables fast and accurate scanning. Due to the arrangement of the cameras and projectors in the distal area of the intraoral scanner, these are limited in size. New solutions would have to be found to realize the microprojector.

According to the invention, this task is solved by a scanning method according to claim 1 and a scanning device according to claim 11. The sub-claims represent preferred embodiments of the invention. The scanning device is used in particular for scanning one or more teeth.

In a first step of the method according to the invention, a color pattern or color stripe pattern is projected onto the surface to be scanned, preferably with the aid of at least one projector. While the color pattern is being projected onto the surface of the teeth, a group of images or image group is recorded simultaneously, either continuously or at short intervals, with the aid of at least three cameras that are arranged in a plane and laterally spaced apart from one another.

This plurality of images comprises a plurality of image groups, wherein the images of the respective image group are recorded simultaneously.

This plurality of images is then or continuously forwarded to a data processor. If necessary, only certain information from these images can be forwarded to the data processor. This variant is preferably included in the concept of forwarding the images to the data processor.

In the data processor, at least two of the at least three images taken simultaneously are compared with each other. These two compared images of an image group are hereinafter referred to as an image pair. When comparing the images, an algorithm is used which is designed to recognize corresponding patterns in the image pair(s).

Corresponding patterns are individual image pixels or areas of pixel within the image pairs that are offset from each other. The depth can be calculated directly from the offset (disparity) of the patterns/the image pixels of the image pair in the form of a depth map. By aligning the camera, the search space for corresponding pixels can be reduced to a line.

In a final step, the depth maps generated from the images of the image groups are merged and the 3D model is finally formed.

The present method also differs from the prior art in that the generated color pattern projected onto the teeth and captured by the cameras has predominantly continuous intensity gradients in the individual color channels. Matching pixels or patterns are then identified by an analysis in the color space. Matching pixels are determined by comparing the directions and lengths of the color vectors in the color space.

The continuity helps to reduce noise in the image.

In the context of the invention, “predominantly continuous” means that jumps may occur due to shading of the projection pattern.

Preferably, at least two image pairs are formed from each image group and examined for corresponding patterns. Thus, at least two depth maps can be generated by calculating the disparity. The depth maps overlap due to the arrangement of the cameras. A depth map is calculated from the at least two depth maps, whereby the quality of the points is evaluated and improved in the overlapping area.

The color patterns can be generated in different ways. According to a preferred embodiment of the invention, the color pattern is generated using three laser diodes and at least one diffractive optical element. According to another embodiment, the three laser diodes, which are located, for example, in a proximal section of a handpiece of the device according to the invention, are connected to the diffractive optical element via optical fibers. The diffractive optical element (DOE) is preferably arranged in the distal section of the handpiece or in the head piece of the device and is positioned in the oral cavity of a patient during the performance of the scan. The diffractive optical element preferably has three areas and ensures that red, green and blue stripes are projected onto the teeth.

According to a second variant of the invention, the color pattern or color stripe pattern is generated by colored LEDs (preferably red, green, blue) and apertures. In this design, the light-emitting elements—here LEDs—are also preferably arranged in the handpiece of the device and connected via optical fibers to aperture assemblies that are arranged in the distal section of the headpiece of the device.

To avoid motion blur in the image, the projection pattern is displayed in a flash for 1 ms. This requires a high pulse light output in the range of 300 mW for the light source; without taking into account the losses due to filters or coupling into the optical fiber.

According to the invention, it is provided that the color patterns are projected at intermittent intervals onto the surface to be captured and that the images of at least one image group are captured during this time of projection.

In addition to the intermittent projection of the color patterns, the light of a white LED is preferably provided to illuminate the surface to be scanned. This makes the surface to be scanned more visible to the human eye and/or to a camera for recording and playback on a screen, and it facilitates the positioning and movement of the distal section of the handpiece of the intraoral scanner in the patient's mouth during the scanning process.

The light of the white LED, or rather the light of the white LED that is reflected by the tooth surface, can also be used to determine the color of the teeth, or rather the surface to be scanned, and to roughly determine the scanned material, such as tooth, gum or metal. For this purpose, an image can be taken with the help of one of the cameras while the surface to be scanned is illuminated with the white LED and forwarded to a data processor. The data processor preferably textures the generated 3D model based on this data. Similarly, according to another embodiment, the color and/or material information can also be stored in the 3D model. According to a further embodiment of the invention, the color and/or material information can be used to optimize the stereomatching and/or to regulate the luminosity of the structured light and/or to adapt the projection pattern to the material or color during the runtime. In this context, the scanner can comprise or be connected to a control unit that is designed to carry out these steps.

Storing the color and material information in the 3D model makes it possible to segment the teeth, identify the gums, palate, braces, metal implants or interfering data such as the cheek or tongue during the scanning process. Using all of this information, it is possible to estimate the accuracy of the scanning process and to provide the user with information about insufficient scanning quality or to show it in the 3D display.

The scanning device according to the invention preferably has an acceleration sensor. If the acceleration or movement detected is above a predetermined threshold, the scanning process is interrupted or terminated in accordance with one embodiment. This means that the scanning process is interrupted if the movements are too vigorous and can be continued again if the movements are more gentle.

According to a further embodiment of the method and device according to the invention, the motion changes detected by the acceleration sensor are compared by a processor with predetermined motion change data stored in a memory unit. This allows the device to be controlled by gestures made by the user.

In contrast to triangulation methods, the method according to the invention principally does not require constant calibrations. Only a factory calibration of the camera optics is provided.

A scanning device according to the invention is proposed for creating three-dimensional images, in particular of a patient's teeth, with the aid of the method described above.

The scanning device according to the invention comprises a handpiece that has a proximal section and a distal section for insertion into the oral cavity of a patient. In addition, the scanning device comprises a data processor and a control unit.

The handpiece is connected to a control unit and to a data processor for the exchange of information. The control unit and/or the data processor can also be arranged in the handpiece. According to one embodiment, the handpiece is connected to the control unit and/or data processor by means of a cable. According to a further embodiment, however, a system for wireless transmission of information between the handpiece and the data processor and/or the control unit can also be provided.

On the distal section of the handpiece there are at least two, typically three cameras, which are used to perform a scan. The three cameras are arranged in one plane. In addition to the embodiment with three cameras, however, embodiments with four or more cameras are also possible.

A system for generating a color stripe pattern or at least components thereof is also located on the distal section. Preferably, the color stripe pattern is generated by means of a diffractive optical element (DOE) together with at least three laser diodes. Preferably, the at least three laser diodes are arranged in the proximal section of the handpiece and connected to the DOE on the distal section of the handpiece via optical fibers.

The DOE preferably has three different areas, so that each of the three laser diodes is optically coupled into a different area of the DOE. Preferably, the three laser diodes are red, green and blue.

According to a particularly preferred embodiment, the DOE is designed to project red, green and blue color stripes having a width of 700 to 1800 micrometers at a distance of 5-15 mm onto the surface to be scanned, in particular the teeth. According to an alternative embodiment, it is provided that the color pattern or color stripe pattern is generated using at least three colored LEDs (red, green and blue) and apertures. It is also provided according to an embodiment, the use of light guides to save space and to prevent heat problems. For example, stripe or triangular patterns or tapered stripes can be generated by the apertures. Surprisingly, it has been found that using apertures that taper in cross-section (from the light inlet to the light outlet) optimizes the light intensity within the projected stripes or within the projected triangle to such an extent that a triangular intensity profile is created, instead of the trapezoidal intensity profile that is otherwise common with apertures.

The control unit of the scanning device is designed to control the cameras arranged on the distal section in order to take a series of pictures simultaneously during the scanning process and to forward them to a data processor. The data processor is designed in accordance with the invention to analyse the recorded images using a stereo-matching method. This allows depth maps of the images to be generated, which are converted into a 3D model by the device's data processor or by an external data processor.

The core of the invention is that the DOEs together with the laser diodes or the LEDs together with the apertures create a pattern that has continuous intensity transitions. The pattern can be implemented by color stripes, a triangular pattern or a combination of white light with color elements such as lines or stripes. The data processor is designed to use changes in the color space to recognize matching patterns in the image pairs.

In addition, the surface to be scanned is illuminated with a white LED offset to the intermittent projection of the color stripe patterns, as explained above. According to one embodiment, the scanning device in the handpiece has a rotating vibration mechanism. This vibration mechanism is designed to set the DOE located on the distal section in motion. The color stripes generated by the DOE and projected onto the surface to be scanned are blurred as a result, which is equivalent to generating continuous intensity transitions of the color stripe pattern. The intensity transition is preferably sinusoidal or approximately sinusoidal. Another important effect here is the reduction of speckles of any kind that are caused in case of use of a laser.

In addition to the option of vibrating around one axis, it is also possible to vibrate around two axes. This makes it possible to create patterns with and without a DOE. Without a DOE—i.e. only with the laser spot—it is possible to create straight lines or Lissajou figures. With a DOE, several stripes and Lissajou figures can be created. The amplitude and frequency of the vibrations can be adjusted during the scanning process; in particular, the pattern and its width can be adapted to the material being scanned. Material detection is possible by means of intermittent white illumination.

A vibration mechanism can also be formed in a 90° deflection in the form of a prism or mirror.

In both embodiments, the laser diodes or the LEDs are operated with a pulse length of between 0.1 and 2.5 ms. About 1 ms is particularly preferred. This time is sufficient for at least one image group, i.e. 3 simultaneously recorded images, to be recorded. The short illumination time can reduce blurring caused by movement, and also allows the use of rolling shutter camera sensors. Rolling shutter sensors are preferred for the cameras of the scanning device due to their size

According to a further variant of the invention, it is envisaged that the control unit is designed to vary the light intensity of the laser diodes or LEDs during the scanning process.

According to a further embodiment of the invention, the control unit is adapted to adjust the light intensity of the laser diodes or LEDs depending on the intensity values of the colors captured by at least one camera.

One advantage of the scanning device according to the invention is the small scanning distance. In order to further reduce this distance, a prism is provided according to one embodiment of the invention, which is arranged in front of the cameras in the optical direction.

Another advantage of the invention is that when using at least three cameras—in particular when the scanning process is carried out over the inner and outer edges of the teeth—the distal section of the handpiece only has to be guided over the outer edge once and over the inner edge of the teeth once (for the upper and lower jaw respectively).

In order to enable the distal section of the handpiece to be guided over the edges of the teeth, “wings” are provided to the side of the cameras of the scanning device in one embodiment of the invention as a guiding aid. The wings are designed and aligned in such a way that when the distal section is guided over the edges of the teeth, said edge can be placed between the wings. In this case, the inner sides of the wings touch either the front and top or the back of the teeth as well as the top of the teeth (especially the molars). The wings are thus designed to lean on the sides mentioned and to enable scanning over the edge. In the context of this invention, the term “scanning over the edge” means that the distal section of the scanning device is moved along the front edge of the teeth and then along the rear edge of the teeth.

For this purpose, the wings are preferably spaced between 1 and 2 mm apart and preferably run at an angle of about 35 degrees to the surface in which the cameras are arranged. They have a height of preferably between 2 and 4 mm. To prevent fogging of the optics of the cameras and the other optically effective components on the distal section of the headpiece of the scanning device, the distal section of the handpiece or the headpiece preferably has a heating element and a temperature sensor. The heating element, together with the temperature sensor and the control unit, ensures that the optically functional components remain above 32°. This helps to prevent fogging of the outer surfaces of these components. Maintaining a constant temperature for the camera and the optical elements also improves measurement accuracy. After scanning in a patient's mouth, at least the distal section of the scanning device handpiece must be autoclaved and is designed accordingly. However, according to a particularly efficient embodiment, the scanning device can also have a snap-on protective cover that can be disposed of or individually autoclaved after each use of the device.

Alternatively, the distal portion of the handpiece can be designed to be attachable to the proximal portion of the handpiece and can be autoclaved as a whole.

According to a further embodiment, the device can have a far range recording mode in addition to the near range scanning function, so that an intraoral overview scan of the dental arch or a recording of the face or a facial area outside the oral cavity can also be carried out.

The invention is described in more detail in the drawings below. The drawings only show preferred embodiments and should not be understood as limiting.

### BRIEF DESCRIPTION OF THE DRAWINGS

FIG. 1 shows a schematic illustration of the intraoral scanner in an embodiment with a diffractive optical element and laser diodes;

FIG. 2 shows an illustration of the intraoral scanner with LEDs and apertures;

FIG. 3A shows a configuration of the scanner head with light guide, DOE and 3 cameras;

FIG. 3B shows a configuration of the scanner head with light guide, deflection element, diaphragm body and 3 cameras;

FIG. 3C shows a cross-section of a aperture body according to one embodiment;

FIG. 4 shows the use of the intraoral scanner on tooth surfaces;

FIG. 5A shows a preferred projection pattern projected onto a flat white surface;

FIG. 5B shows another preferred projection pattern projected onto a flat white surface;

FIG. 5C shows an intensity curve of an image line recorded by the cameras when using a projection pattern according to FIG. 5B;

FIG. 5D shows a further intensity curve of an image line recorded by the cameras when using a projection pattern according to FIG. 5B;

FIG. 6 shows an image group with a pattern projected onto a tooth;

FIG. 7 shows a color gradient of line 50 in the left and middle image with the intensities of red, green and blue; and

FIG. 8 shows the recorded disparity of the left and middle camera, as well as the middle and right camera, as well as a composite disparity map shown in the middle.

### DETAILED DESCRIPTION OF THE PREFERRED EMBODIMENTS

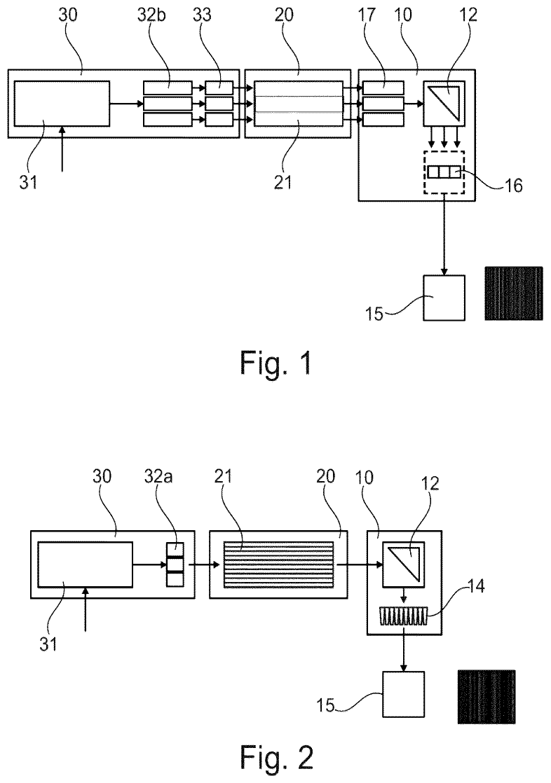

FIG. 1 shows an embodiment of the intraoral scanner according to the invention. The intraoral scanner is divided into a handpiece (30), a neck piece (20), and a scanner head (10). In this design, a power controller (31) is located in the handpiece (30), which supplies the laser diodes (32b)—also located in the handpiece (30)—with power, so that they generate pulsed light with a pulse length of approximately 1 ms. The laser diodes 32b are connected to optical waveguides 21 via a coupler 33, which extends through the neck piece 20 of the scanner.

The optical fibers 21 are optically coupled to a diffractive optical element 16 via a focusing element or lens 17, a 90° deflection element in the form of a prism 12, which is accommodated in the scanner head 10. The lens is preferably a GRIN lens. The diffractive optical element has 3 areas (RGB) and ultimately generates a color pattern for projection onto the teeth of a patient. The cameras of the intraoral scanner are not shown in this illustration.

FIG. 2 shows an embodiment of the intraoral scanner, which has at least three colored LEDs (red, green, blue) instead of laser diodes. As in FIG. 1, a pulsed current of about 1 ms is applied to these LEDs to generate corresponding light flashes. In this design, too, LEDs 32a are arranged in the handpiece 30, and are optically connected to the optical fiber 21 arranged in the neck piece 20. One optical fiber is provided for each aperture.

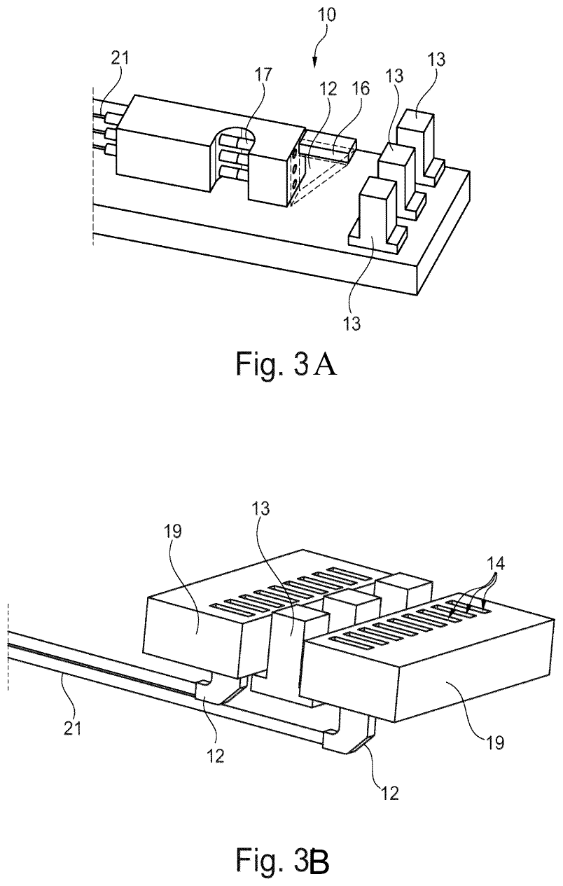

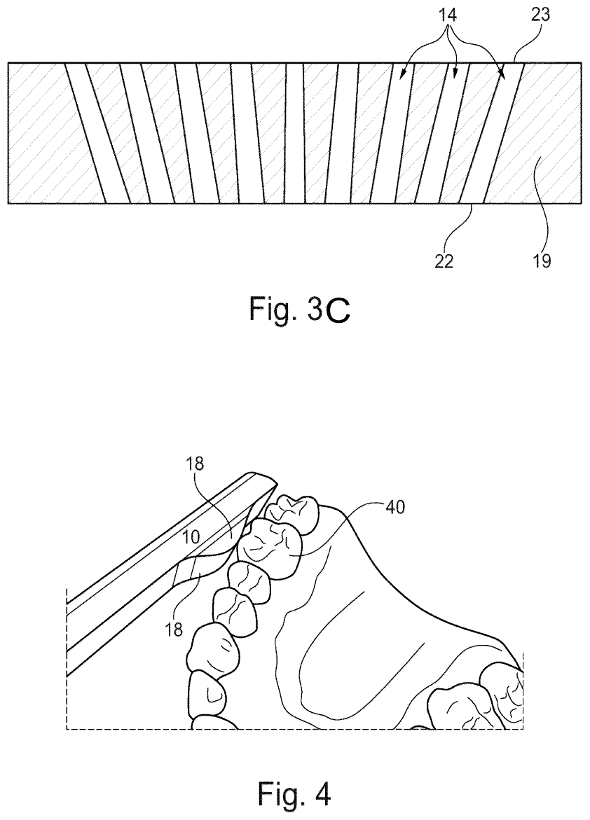

The apertures are arranged in an aperture body 19, as shown in FIG. 3C. Finally, up to 100 mW of power per color emerges from the projection 15 during the light pulse. The cameras of the intraoral scanner are not shown in this illustration.

FIG. 3A is a representation of the scanner head 10 with 3 cameras 13. The cylindrical lenses 17 for focusing are attached to optical fibers 21 (one optical fiber is provided for each color). The laser beams are thereby sent to the diffractive optical element (DOE) 16 via a prism 12. The color pattern is formed in the DOE 16 and projected onto the surface to be scanned—in this case, a patient's teeth 40. The light reflected by the teeth is then captured by the three cameras 13. The signals obtained are then passed on in whole—or at least in part—to a data processor to determine the disparities of the individual pixels. FIG. 3B shows a representation of the components in scanner head 10 according to another embodiment of the intraoral scanner with LEDs. The version with LEDs comprises two aperture bodies 19 in which a plurality of apertures 14 (passage openings) are arranged. The apertures 14 or passage openings preferably have a rectangular, trapezoidal or triangular cross-sectional area. It has been shown that the color patterns, in particular a color stripe pattern or a triangular pattern, can be formed particularly advantageously with two aperture bodies, wherein the respectively corresponding apertures 14 of the two aperture bodies 19, in the case of the color stripe pattern, are aligned with one another, thus continuing the line, or, in the case of a triangular pattern, are arranged offset with respect to one another. Each aperture 14 is connected (not shown here for reasons of clarity) to preferably a red, blue or green LED via an optical fiber 21.

The use of at least two aperture bodies 19, which comprise a plurality of apertures 14 that together generate the projection, is particularly advantageous for intraoral scanners because it allows for a small geometric size of the scanner head 10.

The light emitted by the apertures and reflected by the teeth in the case of treatment is captured by the three cameras 13.

FIG. 3C shows a cross-section through the aperture body 19 in the plane of the apertures 14. Surprisingly, it has been found that a particularly advantageous, continuous intensity distribution of the projection can be achieved when the apertures undergo a cross-sectional reduction starting from the entrance opening 22 in direction to the exit opening 23, i.e. the cross-section of the passage opening tapers. This can result in a preferred triangular intensity distribution. This triangular intensity distribution has much better optical properties for performing a scan than apertures previously known or used in this area, meaning that such an aperture can be regarded as an independently inventive aspect, particularly in connection with intraoral scanners or other preferably medical applications in which the smallest possible dimension needs to be achieved.

FIG. 4 shows the intraoral scanner in use on a dental model 40. In this illustration, it is clear that the scanner is used to scan over the edge of the teeth. In order to guide the scanner accordingly, the scanner head has two wings 18 that laterally limit the plane of the cameras. During scanning, one edge of the teeth—i.e. the inner or outer edge of the teeth—is positioned between the wings 18. The wings are preferably spaced between 1 and 2 mm apart and are at an angle of 35 degrees to the plane of the cameras.

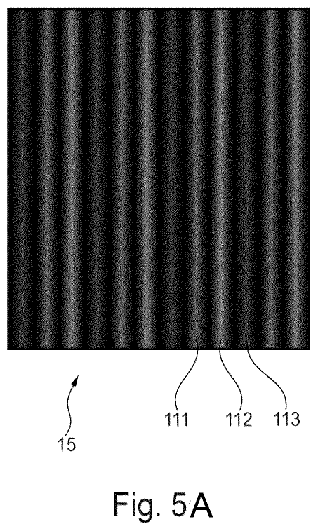

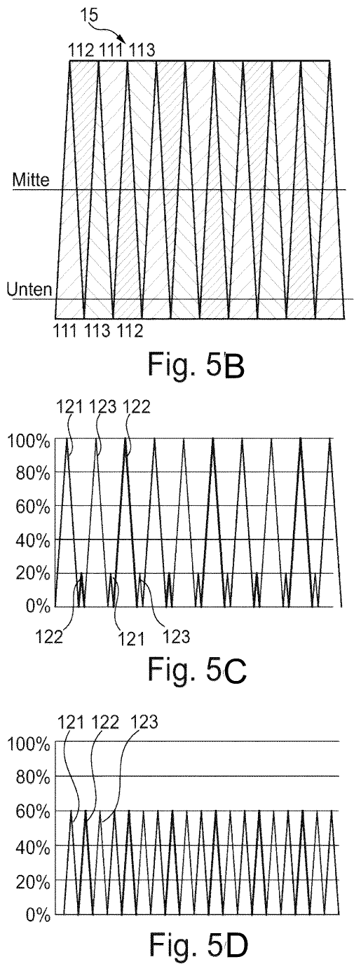

FIG. 5A shows projection 15 of the striped pattern on a white background. According to the embodiment shown here, projection 15 has red, green and blue color stripes 111, 112, 113. The projection distance is preferably between 5 and 15 mm. The stripes are preferably formed by corresponding and aligned apertures 14 in two aperture bodies 19.

FIG. 5B shows projection 15 of a triangular pattern on a white background. The preferred projection distance is between 5 and 15 mm. This variant is generated using LEDs and corresponding apertures 14, which have a triangular cross-section and are arranged on two aperture bodies 19, laterally offset from one another by half the width of the base of the triangle.

Overall, this offset triangular projection allows more color transitions with fewer light sources than a striped projection, in which the stripes are generated by two corresponding and aligned apertures 14 on two aperture bodies 19. Compared to the stripes, color changes also occur in the transverse direction—i.e. from the base of the triangle towards the tip.

FIG. 5C shows the intensity profiles of the middle row of the middle camera image 52 (at optimal aperture) when projecting the triangular color pattern of FIG. 5B on a white background. The aperture or the light source used to create a triangle is located in the wide part of the triangle in terms of distance to the center of the camera (see aperture arrangement in FIG. 3b). Therefore, the intensity decreases noticeably towards the tip as the distance increases.

FIG. 5D shows the intensity curves of a lower line of the middle camera image 52 (with optimal aperture) when projecting the triangular color pattern from FIG. 5B on a white background. Compared to 5C, the intensity peak is also smaller because the distance to the aperture is greater. The differences in the intensity peaks can be reduced by optimizing the aperture. Ideally, the peaks should have the same intensity.

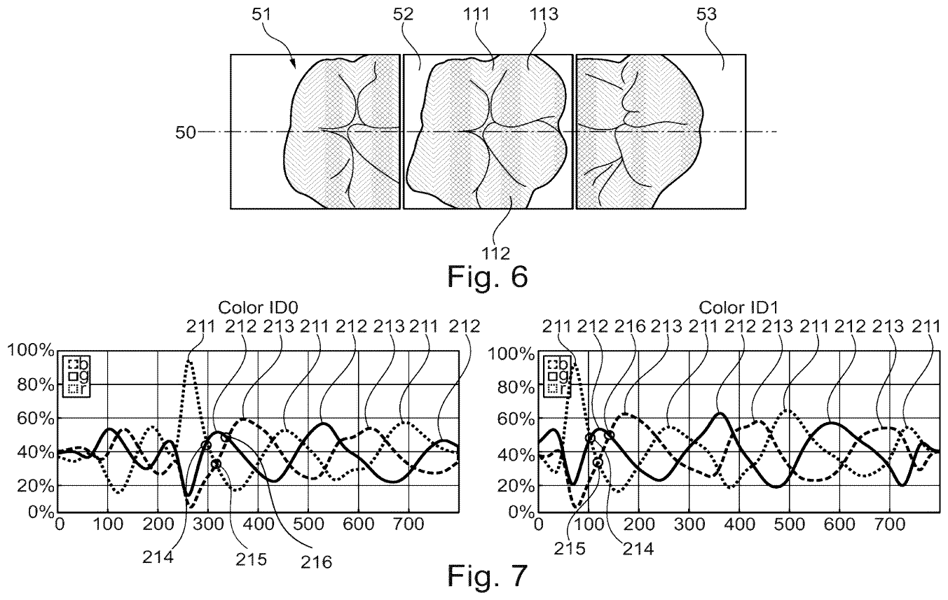

FIG. 6 shows three camera images 51, 52 and 53, in which the projection according to FIG. 5a was recorded on the surface of a tooth model 40. The individual color stripes red 111, green 112 and blue 113 are additionally smoothed by the optical properties of the tooth and thus blend into one another. Due to the uneven surface of the teeth, the individual stripes in the projection are no longer purely parallel to one another. The straight line 50 represents a camera line that is analyzed in FIG. 7 with regard to the color gradient. FIG. 7 shows the intensity profile of the individual colors along the camera line 50 of FIG. 6 for two cameras. It shows that the color stripes 111, 112 and 113 create minima and maxima in a camera line 50. If comparing the intensity of the individual colors, similar curves and corresponding points (maxima 211, 212, 213) or intersections (214, 215, 216) can be seen. Further values in between can also be assigned. The displacement of the individual image pixels (disparity) within the line can thus be determined point by point. The stereo matching algorithm is more complex but is based on this assignment. It analyzes not only point by point but also entire areas

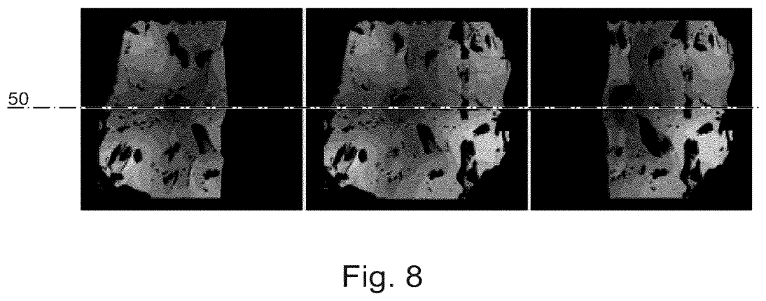

FIG. 8 shows three disparity maps-one (left map) from the left camera to the center camera and (right map) from the center to the right camera and (middle map) a combined disparity map. The disparity was calculated in each case relative to the center camera. The depth can be determined from the disparity. Dark points indicate that the disparity cannot be determined or cannot be determined with sufficient accuracy. Light values indicate a high disparity or proximity to the camera. The left disparity map is limited on the right side, the right one on the left side, because the disparity can only be determined for areas that the corresponding cameras can “see”.

The two disparity maps have an overlap area where two disparity values can be obtained for each image pixel. This allows the center map to be calculated, which shows higher-precision disparity or depth values in the overlap area.

### LIST OF REFERENCE NUMERALS

10 Scanner head
12 Deflection element with prism or mirror
13 Camera
14 Aperture(s)
15 Projection
16 Diffractive optical element
17 Focusing elements/lens
18 Wing/guidance
19 Aperture body
20 Neck piece
21 Light guide
22 Entrance aperture
23 Exit aperture
30 Handpiece
31 Power controller
32a LEDs
32b Laser diodes
33 Coupling into light guide
40 Tooth surface/model
50 Camera line
51 Left camera image
52 Center camera image
53 Right camera image
111 Color filter strip red
112 Color filter strip green
113 Color filter strip blue
121 Color intensity red
122 Color intensity green
123 Color intensity blue
211 Maxima red
212 Maxima green
213 Maxima blue
214 Equal intensities red/green
215 Equal intensities red/blue
216 Equal intensities green/blue

1. A method for creating three-dimensional images using a scanning device, comprising the steps of:
projecting a color pattern (111, 112, 113) onto a surface (40) to be captured,
recording a plurality of images using at least three cameras (13) that are spaced apart and arranged in a plane,
the plurality of images comprising a plurality of image groups, each containing images taken simultaneously with the aid of the at least three cameras (13), forwarding the plurality of images to a data processor, comparing at least two of the images taken simultaneously by the at least three cameras (13) (image pair),
detecting corresponding patterns in the image pair, which respectively correspond to the same local area of the surface (40) to be detected,
calculating the displacement of individual image pixels of the corresponding patterns or of the image pixels of the image pair,
creating at least one depth map with depth information from at least one image pair,
combining the depth maps generated from the images of the image groups,
wherein the color pattern (111, 112, 113) projected onto a surface (40) and detected by the cameras (13) generates predominantly continuous intensity profiles in the individual color channels, and wherein matching pixels or patterns in the image pairs are detected by comparing the directions and lengths of the color vectors in the color space, characterized in that the color pattern (111, 112, 113) is projected intermittently onto the surface (40) to be detected and the images of at least one image group are detected within the projection period.

2. The method according to claim 1, characterized in that a white LED illuminates the surface (40) to be detected intermittently and offset in relation to the projection of the color pattern (111, 112, 113).

3. The method according to claim 2, characterized in that the reflection of the light emitted by the white LED is captured and used to determine the color and/or material of the surface (40) to be scanned.

4. The method according to claim 2, characterized in that the reflection of the light emitted by the white LED is captured and additionally used to create a depth map.

5. The method according to claim 1, characterized in that at least two image pairs are formed in each image group and are examined for corresponding patterns in each case.

6. The method according to claim 1, characterized in that the depth information from at least two image pairs of an image group are compared with each other to achieve a higher information quality and reliability.

7. The method according to claim 1, characterized in that the color pattern is generated by means of three laser diodes (32b) and at least one diffractive optical element (16) or by means of colored LEDs (32a) and (tapered) apertures.

8. The method according to claim 1, characterized in that the scanning process is interrupted if the detected motion of the cameras (13) is above a predetermined threshold and is automatically resumed if the motion of the cameras (13), detected by means of an acceleration sensor, is below a predetermined threshold.

9. The method according to claim 1, characterized in that the scanning method is controlled (gestures) by comparing recorded acceleration patterns with acceleration patterns stored in a memory.

10. The method according to claim 1, characterized in that, in contrast to triangulation methods, no calibration is required before or during the scan.

11. A scanning device for performing an intraoral scan for dental purposes, comprising:
a control unit, a data processor located in the handpiece (30) of the intraoral scanner,
a handpiece (30) connected to the data processor for exchanging information, with a distal section (10) intended for insertion into the oral cavity of a patient, wherein at least three cameras (13) arranged in a plane and at least one diffractive optical element (16) or at least one aperture (14) are arranged in the distal section, wherein the diffractive optical element(s) (16) together with at least one laser diode (32b) or the apertures (14) together with at least three LEDs (32a) are designed to project a color pattern (111, 112, 113) onto the surface (40) to be scanned during the scanning process, and
wherein the data processor is configured to generate depth maps using the images recorded during the scanning process by applying the stereo matching method and to transfer them to a procedure for composing the depth maps, characterized in that the color pattern (111, 112, 113) projected onto a surface (40) and detected by the cameras (13) produces predominantly continuous intensity profiles in the individual color channels, and the data processor is designed to use changes in the color space to recognize matching patterns in the image pairs.

12. The scanning device according to claim 11, wherein a diffractive optical element (16) having 3 regions is optically connected via optical fibers to 3 laser diodes (32b) (red, green, blue) arranged in a proximal portion of the handpiece (30) for generating the color patterns (111, 112, 113).

13. The scanning device according to claim 11, wherein a vibration mechanism is provided to generate continuous intensity transitions of the color pattern (111, 112, 113), said mechanism vibrating the diffractive optical element or a 90° deflection element (micro-mirror on MEMS basis) and thereby “blurring” the color patterns and reducing the speckles.

14. The scanning device according to claim 11, characterized in that the laser beams are coupled directly into the diffractive optical element(s) (16) without optical fibres (21).

15. The scanning device according to claim 11, wherein the LEDs are each connected via optical fibers to at least one aperture (14) per color.

16. The scanning device according to claim 11, characterized in that “wings” are arranged on the scanner head (10) of the scanning device laterally with respect to the cameras (13) of the scanning device as a guiding aid (18), which allows the scanner head (10) to be guided along the inner edge and along the outer edge of the cheek teeth.
